(19) United States
(12) Patent Application Publication
(10) Pub. No.: US 2026/0087361 A1
(43) Pub. Date: Mar. 26, 2026

(54) SYSTEMS, METHODS, AND MEDIA FOR ANOMALY DETECTION

(71) Applicant: The Trustees of Columbia University in the City of New York, New York, NY (US)

(72) Inventors: Xiao-Yang Liu, New York, NY (US); Xiaodong Wang, Ramsey, NJ (US); Zhenyan Huang, Medford, MA (US)

(21) Appl. No.: 19/342,459

(22) Filed: Sep. 26, 2025

Related U.S. Application Data
(60) Provisional application No. 63/699,649, filed on Sep. 26, 2024.
(60) Provisional application No. 63/889,201, filed on Sep. 26, 2025.

(51) Int. Cl. G06N 3/092

(52) U.S. Cl. CPC G06N 3/092

(57) ABSTRACT

Mechanism for anomaly detection are provided, the mechanisms including: initializing a policy network; sampling a mini-batch of data from a training data set, wherein each mini-batch has a plurality of sample sequences, each having a plurality of time steps; for each time step of each sample sequence in each mini-batch: determining an action to be taken based on the policy of the network; and determining a reward; determining a gradient of an expected discounted cumulative reward; and updating the policy network.

### CROSS-REFERENCE TO RELATED APPLICATION

This application claims the benefit of U.S. Provisional Patent Application No. 63/699,649, filed Sep. 26, 2024, and U.S. Provisional Patent Application No. 63/889,201, filed Sep. 26, 2025, each of which is hereby incorporated by reference herein in its entirety.

### BACKGROUND

Anomaly detection, the task of identifying unusual patterns or outliers, is a crucial task in many fields such as critical infrastructure monitoring, industrial process control, environmental monitoring, cybersecurity, and finance. It offers a proactive approach to identifying outliers and anomaly behaviors, allowing organizations to preemptively address critical issues.

Existing mechanisms for anomaly detection are insufficient.

Accordingly, new mechanisms for anomaly detection are desirable.

### SUMMARY

In accordance with some embodiments, new mechanisms, including systems, methods, and media for anomaly detection are provided.

In some embodiments, methods for anomaly detection are provided, the methods comprising: initializing a policy network; sampling a mini-batch of data from a training data set, wherein each mini-batch has a plurality of sample sequences, each having a plurality of time steps; for each time step of each sample sequence in each mini-batch: determining an action to be taken based on the policy of the network; and determining a reward; determining a gradient of an expected discounted cumulative reward; and updating the policy network.

### BRIEF DESCRIPTION OF THE DRAWINGS

FIG. 1 is an example of a general sequential procedure for quickest change detection (QCD) in accordance with some embodiments.

FIG. 2 is an example of a network architecture for implementing a first algorithm for anomaly detection in accordance with some embodiments.

FIG. 3 is an example of a first reward function in accordance with some embodiments.

FIG. 4 is an example of a network architecture for implementing a second algorithm for anomaly detection in accordance with some embodiments.

FIG. 5 is an example of a second reward function in accordance with some embodiments.

FIG. 6 is an example of pseudo-code for a first algorithm for anomaly detection in accordance with some embodiments.

FIG. 7 is an example of pseudo-code for a second algorithm for anomaly detection in accordance with some embodiments.

FIG. 8 is an example of hardware that can be used in accordance with some embodiments.

### DETAILED DESCRIPTION

In accordance with some embodiments, new mechanisms, including systems, methods, and media for anomaly detection are provided.

In accordance with some embodiments, policy-based neural networks for quickest change detection (QCD) are provided. In some embodiments, these neural networks are trained to maximize a total reward defined for a change detection problem. In some embodiments, it is assumed that an underlying time series data stream being monitored for anomalies has a general time dependence.

In accordance with some embodiments, under a general probabilistic policy framework of maximizing the total reward, three neural network-based QCD algorithms are presented: a policy-gradient (PG) QCD algorithm; and two actor-critic (AC) QCD algorithms.

Let x₁, x₂, . . . , x_{τ-1}, x_{τ}, x_{τ+1}, . . . denote a data sequence, where xₜ∈ [symbol] is an observation at time t and p≥1 is its dimension. Assume that a change occurs at time τ≥0. Also assume that observations before t and after t follow two different distributions, i.e.,

$${x}_{t} ∼ \{ \begin{matrix}{f}_{0} , & if t < τ , \\ {f}_{1} , & if t \geq τ ,\end{matrix} \qquad ( 1 )$$

where f₀ and f₁ are the pre- and post-change probability density functions, respectively.

In accordance with some embodiments, at each time t, after observing xₜ, and based on some accumulated statistic, a decision can be made either to declare a change (anomaly), i.e., aₜ=1, or to wait for more observations, i.e., aₜ=0. Let a random variable I represent the first time that a change is declared. Then {Γ<τ} corresponds to a false alarm event and (Γ−τ)⁺ is the detection delay, where (⋅)⁺≙max{0,⋅}.

In accordance with some embodiments, in a quickest change detection (QCD) approach, an objective is to minimize both a detection delay and a probability of false alarm.

In some embodiments, a decision-making process uses fully sequential procedures, which decide whether an anomaly has occurred based on an entire observation history of a data sequence by keeping a summary of the observations seen so far in internal memory.

Let St represent the internal state representation (memory) of a decision maker at time t, based on the observations up to t. Ideally, the internal state sₜ captures and summarizes all relevant information in the observation history and as new observations are made, sₜ is updated accordingly. (It should be understood that maintain an internal state sₜ that captures and/or summarizes all relevant information in the observation history and as new observations are made may not be possible or practicable, and is not required, in some embodiments.)

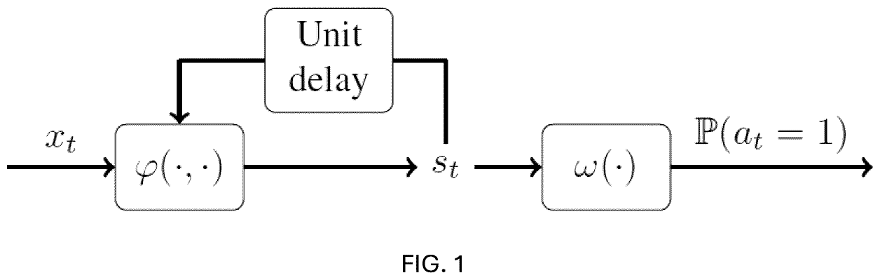

In accordance with some embodiments, as shown in FIG. 1, a general sequential procedure for QCD includes two functions: φ(⋅,⋅); and ω(⋅). Let φ(⋅,⋅) be a function that processes the latest observation xₜ and updates the internal state, as given by

$${s}_{t} = φ ( {x}_{t} , {s}_{t - 1} ) . \qquad ( 6 )$$

As shown in the figure, the internal state sₜ is then mapped to a probabilistic decision rule via a function ω(⋅) as

$$ℙ ( {a}_{t} = 1 ) = ω ( {s}_{t} ) . \qquad ( 7 )$$

### Policy Gradient OCD Methods

In accordance with some embodiments, policy gradient QCD methods can be implemented and are now further described.

Denote x^{t}=(x₁, . . . , xₜ). Starting from t=1, decisions are made as to whether an anomaly has occurred by following a probabilistic policy π_{θ} until the first alarm is raised at time t₀, in some embodiments. A stopping time can be defined as Γ=t₀. Under a general QCD framework, π_{θ} can be a composition of the decision function ω(⋅) and the state update function φ(⋅,⋅), where θ is the parameters of the policy. In some embodiments, a goal of this approach can be to determine a probabilistic policy π_{θ}, which maps the input sequence x^{t} to the probabilities [symbol] (aₜ=1)=π_{θ}(x^{t}) and [symbol] (aₜ=0)=1−π_{θ}(x^{t}). The subsequent actions for t>Γ are aₜ=1 as an alarm has been raised (and possibly a corrective action taken) at t=Γ. So, in accordance with some embodiments, an overall policy can be:

$${Π}_{θ} ( {a}_{t} = 1 \vert {x}^{t} ) = \{ \begin{matrix}{π}_{θ} ( {x}^{t} ) , & if t \leq Γ , \\ 1 , & otherwise ,\end{matrix} \qquad ( 12 )$$

$$and {Π}_{θ} ( {a}_{t} = 0 \vert {x}^{t} ) = 1 - {Π}_{θ} ( {a}_{t} = 1 \vert {x}^{t} ) .$$

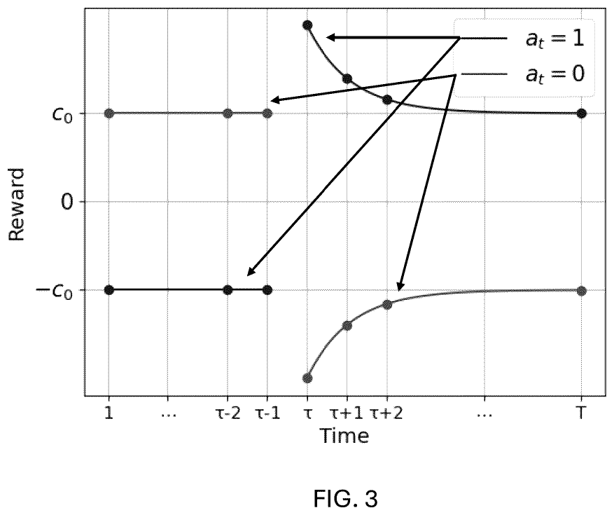

In some embodiments, a reward can be assigned each time a decision is made. As shown in FIG. 3, a reward function can be defined as follows,

$$R ( {x}^{t} , {a}_{t} ) = \{ \begin{matrix}{c}_{0} & if t < τ , {a}_{t} = 0 , \\ - {c}_{0} & if t < τ , {a}_{t} = 1 , \\ {c}_{t} & if t \geq τ , {a}_{t} = 1 , \\ - {c}_{t} & if t \geq τ , {a}_{t} = 0 ,\end{matrix} \qquad ( 13 )$$

where the constants c₀>0 and c_{τ}≥c_{τ+1}≥ . . . >0, emphasizing the importance of observations just after the change. As shown in the figure, the reward is positive if the decision is correct, i.e., choosing aₜ=0 when t<τ and choosing aₜ=1 when t≥τ; and otherwise the reward is negative.

In some embodiments, a next state xₜ₊₁ is independent of the agent's actions because the agent only evaluates the status of the state but does not interfere with its transitions. Also, in some embodiments, the state is in general non-Markovian, i.e., xₜ₊₁ depends on all past states x^{t}.

In some embodiments, a trajectory of a sequence in a detection task can be defined as: [symbol] =(x¹, a₁, x², a₂, . . . , x^{Γ}, a_{Γ}, . . . x^{T}, a_{T}). Following Π_{θ}, the probability density of a trajectory [symbol] can be:

$$p ( 𝒯 \vert θ ) = p ( {x}_{1} ) {\prod }_{t = 2}^{T} p ( {x}_{t} \vert {x}^{t - 1} ) {\prod }_{t = 1}^{T} {Π}_{θ} ( {a}_{t} \vert {x}^{t} ) \qquad ( 14 )$$

where p(x₁) and p(xₜ|x^{t-1}) for 2≤t<τ follow the pre-change distribution f₀ and p(xₜ|x^{t-1}) for t≥τ follow the post-change distribution f₁. In some embodiments, a goal is to maximize the expected discounted cumulative reward:

$$J ( θ ) = {𝔼}_{{\prod }_{θ}} [ {\sum }_{t = 1}^{T} {γ}^{t} R ( {x}^{t} , {a}_{t} ) ] = {\int }_{𝒯} {\sum }_{t = 1}^{T} {γ}^{t} R ( {x}^{t} , {a}_{t} ) p ( 𝒯 \vert θ ) , \qquad ( 15 )$$

where γ is the discount factor with 0<γ<1 and R(x^{t}, aₜ) is the reward received at the time t given by (13).

In some embodiments, the gradient of the log probability of a trajectory can be given by:

$$\begin{matrix}{∇}_{θ} log p ( 𝒯 \vert θ ) = {∇}_{θ} log p ( {x}_{1} ) + {\sum }_{t = 2}^{T} {∇}_{θ} log p ( {x}_{t} \vert {x}^{t - 1} ) + {\sum }_{t = 1}^{T} {∇}_{θ} log {Π}_{θ} ( {a}_{t} \vert {x}^{t} ) \\ = {\sum }_{t = 1}^{T} {∇}_{θ} log {Π}_{θ} ( {a}_{t} \vert {x}^{t} ) \\ = \{ \begin{matrix}{\sum }_{t = 1}^{Γ - 1} [ {∇}_{θ} log ( 1 - {π}_{θ} ( {x}^{t} ) ) ] + {∇}_{θ} log {π}_{θ} ( {x}^{Γ} ) + {\sum }_{t = Γ + 1}^{𝒯} {∇}_{θ} log 1 , & if Γ \leq T - 1 , \\ {\sum }_{t = 1}^{Γ - 1} [ {∇}_{θ} log ( 1 - {π}_{θ} ( {x}^{t} ) ) ] + {∇}_{θ} log {π}_{θ} ( {x}^{Γ} ) , & if Γ = T , \\ {\sum }_{t = 1}^{T} [ {∇}_{θ} log ( 1 - {π}_{θ} ( {x}^{t} ) ) ] , & no Γ ,\end{matrix} \\ = \{ \begin{matrix}{\sum }_{t = 1}^{Γ - 1} [ {∇}_{θ} log ( 1 - {π}_{θ} ( {x}^{t} ) ) ] + {∇}_{θ} log {π}_{θ} ( {x}^{Γ} ) , & if Γ \leq T , \\ {\sum }_{t = 1}^{T} [ {∇}_{θ} log ( 1 - {π}_{θ} ( {x}^{t} ) ) ] , & no Γ .\end{matrix}\end{matrix} \qquad ( 16 )$$

Then, in some embodiments, the gradient of J(θ) in (15) can be given by:

$$\begin{matrix}{∇}_{θ} J ( θ ) = {\int }_{𝒯} {\sum }_{t = 1}^{T} {γ}^{t} R ( {x}^{t} , {a}_{t} ) {∇}_{θ p} ( 𝒯 \vert θ ) \\ = {\int }_{𝒯} p ( 𝒯 \vert θ ) {∇}_{θ} log p ( 𝒯 \vert θ ) {\sum }_{t = 1}^{T} {γ}^{t} R ( {x}^{t} , {a}_{t} ) \\ = 𝔼 [ {\sum }_{t = 1}^{T} {γ}^{t} R ( {x}^{t} , {a}_{t} ) {∇}_{θ} log p ( 𝒯 \vert θ ) ] \\ = \{ \begin{matrix}𝔼 [ ( {\sum }_{t = 1}^{Γ - 1} {∇}_{θ} log ( 1 - {π}_{θ} ( {x}^{t} ) ) + {∇}_{θ} log {π}_{θ} ( {x}^{Γ} ) ) ( {\sum }_{t = 1}^{Γ - 1} {γ}^{t} R ( {x}^{t} , 0 ) + {\sum }_{t = Γ}^{T} {γ}^{t} R ( {x}^{t} , 1 ) ) ] , & if Γ \leq T \\ 𝔼 [ ( {\sum }_{t = 1}^{T} {∇}_{θ} log ( 1 - {π}_{θ} ( {x}^{t} ) ) ) ( {\sum }_{t = 1}^{𝒯} {γ}^{t} R ( {x}^{t} , 0 ) ) ] , & no Γ .\end{matrix}\end{matrix} \qquad ( 17 )$$

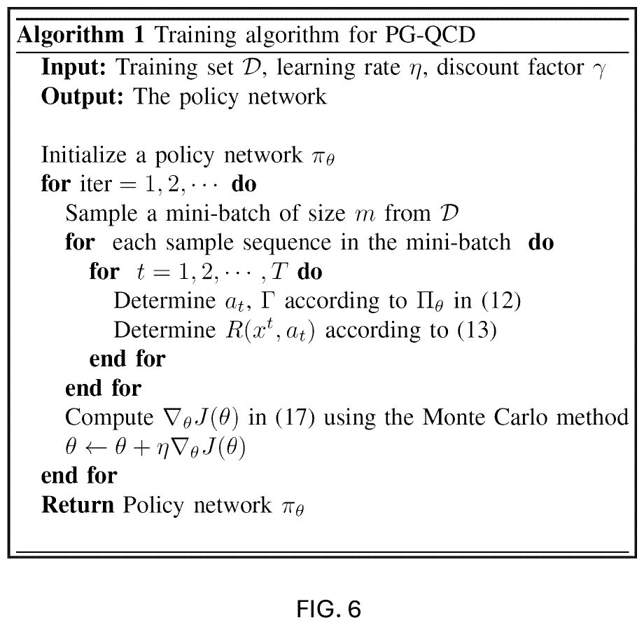

In accordance with some embodiments, one implementation of a training algorithm for policy gradient (PG)-QCD algorithm is given in Algorithm 1, shown in FIG. 6. As shown in this figure, the algorithm receives a training data set, a learning rate value, and a discount factor and output a policy network. Any suitable training data set, learning rate value (e.g., 0.001), and discount factor (e.g., 0.9) can be used in some embodiments.

In some embodiments, Algorithm 1 can operate as follows:

During training, the algorithm can first initialize the policy network. The policy network can be initialized in any suitable manner, in some embodiments.

Then, for each of a given number of iterations, the algorithm can sample a mini-batch of data from the training data set. Any suitable number of iterations, any suitable mini-batch of data, and any suitable sizes of mini-batches can be used in some embodiments.

Then, for each time step of each sample sequence in each mini-batch, the algorithm can determine an action to be taken and a detection time (if any) based on the policy of the network as described in (12), and also determine a reward as described in (13).

Then, for each iteration, the algorithm can determine the gradient of the expected discounted cumulative reward in (17) using the Monte Carlo method, and then update the policy.

After the iterations are complete, the Algorithm can output a policy network that is used to determine if an anomaly has occurred.

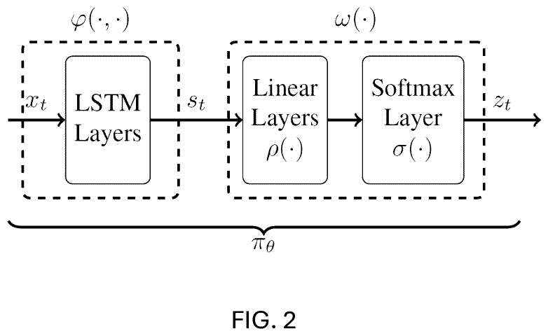

In some embodiments, this algorithm can be implemented in the network architecture as shown in FIG. 2. The network outputs π_{θ}(x^{t}) and make decisions until a_{Γ}=1 at time I, and the subsequent decisions for t>Γ are aₜ=1, in some embodiments. In some embodiments, the reward at each time is recorded. To compute the gradient in (17), the Monte Carlo method using the mean of a mini-batch of samples can be used, in some embodiments.

In some embodiments, in the network structure of PG-QCD shown in FIG. 2, the single LSTM layer's input dimension can equal the data dimension and the output dimension can be 16 (or any other suitable value), and the linear layer group p can be composed of two (or any other suitable number) linear layers with 10 (or any other suitable number) neurons and 1 (or any other suitable number) neuron, respectively.

In some embodiments, in the network structure of PG-QCD of FIG. 2, there can be 2 (or any other number) LSTM layers with a dropout rate of 0.25 (or any other suitable value) and their hidden/output states' dimensions are both 64 (or any other suitable value). The linear layer group p is composed of 2 (or any other suitable number) linear layers with 64 (or any other suitable number) neurons and 1 (or any other suitable number) neuron, respectively.

In some embodiments, the reward can be

$${c}_{t} = \{ \begin{matrix}{c}_{0} , & if t < τ , \\ {c}_{0} + a \times {b}^{t - τ} , & if t \geq τ ,\end{matrix}$$

where, c₀=1, a=1, b=0.5, or any other suitable values.

### Actor-Critic OCD Algorithms

In accordance with some embodiments, actor-critic QCD algorithms are now further described.

In some embodiments, an actor-critic algorithm to maximize the cumulative reward J(θ) in (15) can be implemented. In some embodiments, the actor controls the policy π_{θ}, and the critic aims to estimate cumulative rewards using a value network. Given an actor, the critic can learn to estimate the discounted cumulative rewards based on the available observations using the actor's policy, in some embodiments. Given a critic, the actor can improve its policy by maximizing the discounted cumulative rewards estimated by the critic, in some embodiments.

In some embodiments, the training process works by alternating between policy evaluation and policy improvement, i.e., optimizing the actor and the critic alternatively.

In some embodiments, two kinds of value functions are defined for the critic. The value function of a sequence V(x^{t}) is defined as the expected discounted cumulative reward starting from x^{t} and following Π_{θ}, i.e.,

$$V ( {x}^{t} ) = {𝔼}_{{\prod }_{θ}} [ {\sum }_{{t}^{′} = t}^{T} {γ}^{{t}^{′} - t + 1} R ( {X}^{{t}^{′}} , {A}_{{t}^{′}} ) \vert {X}^{t} = {x}^{t} ] . \qquad ( 19 )$$

Similarly, the value function of a sequence and an action W(x^{t}, aₜ) is defined as the expected discounted cumulative reward starting from x^{t}, choosing at and following Π_{θ}, i.e.,

$$W ( {x}^{t} , {a}_{t} ) = {𝔼}_{{\prod }_{θ}} [ {\sum }_{{t}^{′} = t}^{T} {γ}^{{t}^{′} - t + 1} R ( {X}^{{t}^{′}} , {A}_{{t}^{′}} ) \vert {X}^{t} = {x}^{t} , {A}_{t} = {a}_{t} ] . \qquad ( 20 )$$

In (19)-(20), X^{t} and Aₜ denote the random variables for observation sequences and decisions respectively.

In some embodiments, the gradient of J(θ) in (15) in terms of W(x^{t}, aₜ) can be re-written as follows:

$$\begin{matrix}{∇}_{θ} J ( θ ) = {𝔼}_{{\prod }_{θ}} [ {{\sum }^{T}}_{t = 1} {γ}^{t} R ( {x}^{t} , {a}_{t} ) ] & \\ = {∇}_{θ} [ {\int }_{{x}_{1}} p ( {x}_{1} ) V ( {x}^{1} ) ] & \\ = {∇}_{θ} [ {\int }_{{x}_{1}} p ( {x}_{1} ) {\sum }_{{a}_{1}} {Π}_{θ} ( {a}_{1} \vert {x}^{1} ) W ( {x}^{1} , {a}_{1} ) ] & correspond to ( 20 ) \\ = {\int }_{{x}_{1}} p ( {x}_{1} ) {\sum }_{{a}_{1}} ( {∇}_{θ} {Π}_{θ} ( {a}_{1} \vert {x}^{1} ) W ( {x}^{1} , {a}_{1} ) + {Π}_{θ} ( {a}_{1} \vert {x}^{1} ) {∇}_{θ} W ( {x}^{1} , {a}_{1} ) ) & product rule of derivative \\ = {\int }_{{x}_{1}} p ( {x}_{1} ) {\sum }_{{a}_{1}} ( {∇}_{θ} {Π}_{θ} ( {a}_{1} \vert {x}^{1} ) W ( {x}^{1} , {a}_{1} ) + {Π}_{θ} ( {a}_{1} \vert {x}^{1} ) {\int }_{{x}_{2}} γ p ( {x}_{2} \vert {x}^{1} ) {∇}_{θ} ( R ( {x}^{1} , {a}_{1} ) + γ V ( {x}^{2} ) ) ) & expand W ( {x}^{1} , {a}_{1} ) \\ = {\int }_{{x}_{1}} p ( {x}_{1} ) {\sum }_{{a}_{1}} ( {∇}_{θ} {Π}_{θ} ( {a}_{1} \vert {x}^{1} ) W ( {x}^{1} , {a}_{1} ) + {Π}_{θ} ( {a}_{1} \vert {x}^{1} ) {\int }_{{x}_{2}} γ p ( {x}_{2} \vert {x}^{1} ) {∇}_{θ} V ( {x}^{2} ) ) & R ( {x}^{1} , {a}_{1} ) contains no θ \\ = {\int }_{{x}_{1}} p ( {x}_{1} ) {\sum }_{{a}_{1}} ( {∇}_{θ} {Π}_{θ} ( {a}_{1} \vert {x}^{1} ) W ( {x}^{1} , {a}_{1} ) + {Π}_{θ} ( {a}_{1} \vert {x}^{1} ) {\int }_{{x}_{2}} γ p ( {x}_{2} \vert {x}^{1} ) {\sum }_{{a}_{2}} ( {∇}_{θ} {Π}_{θ} ( {a}_{2} \vert {x}^{2} ) W ( {x}^{2} , {a}_{2} ) + {Π}_{θ} ( {a}_{2} \vert {x}^{2} ) {\int }_{{x}_{3}} γ p ( {x}_{3} \vert {x}^{2} ) {∇}_{θ} V ( {x}^{3} ) ) ) & unroll {∇}_{θ} V ( {x}^{2} ) \\ = … = {{\sum }^{T}}_{t = 1} {γ}^{t} {\int }_{{x}^{t}} {\sum }_{{a}_{t}} p ( {x}^{t} ) {∇}_{θ} {Π}_{θ} ( {a}_{t} \vert {x}^{t} ) W ( {x}^{t} , {a}_{t} ) & repeat unrolling \\ = {{\sum }^{T}}_{t = 1} {γ}^{t} {\int }_{{x}^{t}} {\sum }_{{a}_{t}} p ( {x}^{t} ) {Π}_{θ} ( {a}_{t} \vert {x}^{t} ) {∇}_{θ} log {Π}_{θ} ( {a}_{t} \vert {x}^{t} ) W ( {x}^{t} , {a}_{t} ) & log derivative trick \\ = {{\sum }^{T}}_{t = 1} {γ}^{t} 𝔼 [ {∇}_{θ} log {Π}_{θ} ( {a}_{t} \vert {x}^{t} ) W ( {x}^{t} , {a}_{t} ) ] & back to expectation \\ = {{\sum }^{T}}_{t = 1} {γ}^{t} 𝔼 [ {∇}_{θ} log {Π}_{θ} ( {a}_{t} \vert {x}^{t} ) ( W ( {x}^{t} , {a}_{t} ) - b ( {x}^{t} ) ) ] & Proved in ( 21 ) \\ = \{ \begin{matrix}𝔼 [ {\sum }_{t = 1}^{Γ - 1} {γ}^{t} {∇}_{θ} log ( 1 - {π}_{θ} ( {x}^{t} ) ) ( W ( {x}^{t} , 0 ) - b ( {x}^{t} ) ) + {∇}_{θ} log {π}_{θ} ( {x}^{Γ} ) ( W ( {x}^{t} , 1 ) - b ( {x}^{t} ) ) ] , 1 ) ) ] , if Γ \leq T , \\ 𝔼 [ {\sum }_{t = 1}^{T} {γ}^{t} {∇}_{θ} log ( 1 - {π}_{θ} ( {x}^{t} ) ) ( W ( {x}^{t} , 0 ) - b ( {x}^{t} ) ) ] , no Γ .\end{matrix} & \end{matrix} \qquad ( 18 )$$

Note that for t≤Γ, the decisions follow π_{θ},

$$\begin{matrix}𝔼 [ b ( {x}^{t} ) {∇}_{θ} log {π}_{θ} ( {a}_{t} \vert {x}^{t} ) ] = {\int }_{{x}^{t}} p ( {x}^{t} ) {\sum }_{{a}_{t}} {π}_{θ} ( {a}_{t} \vert {x}^{t} ) {∇}_{θ} log {π}_{θ} ( {a}_{t} \vert {x}^{t} ) b ( {x}^{t} ) \\ = {\int }_{{x}^{t}} p ( {x}^{t} ) b ( {x}^{t} ) {\sum }_{{a}_{t}} {∇}_{θ} {π}_{θ} ( {a}_{t} \vert {x}^{t} ) \\ = {\int }_{{x}^{t}} p ( {x}^{t} ) b ( {x}^{t} ) {∇}_{θ} {\sum }_{{a}_{t}} {∇}_{θ} {π}_{θ} ( {a}_{t} \vert {x}^{t} ) \\ = {\int }_{{x}^{t}} p ( {x}^{t} ) b ( {x}^{t} ) {∇}_{θ} 1 = 0 ,\end{matrix} \qquad ( 21 )$$

where b(x^{t}) is any baseline term depending only on x^{t}.

Based on (18), two actor-critic algorithms can be implemented, in some embodiments.

### First Actor-Critic Algorithm

A first actor-critic algorithm in accordance with some embodiments can be referred to herein as Actor-Critic Algorithm 1 (AC1-QCD), and is now described.

Note that W(x^{t}, aₜ) defined in (20) can be written recursively as follows:

$$\text{?} \qquad ( 22 )$$

$$\text{?} \text{indicates text missing or illegible when filed}$$

In some embodiments, a critic network w_{φ}(x^{t}, aₜ) with parameter φ to estimate W(x^{t}, aₜ) can be used. Given the policy Π_{θ}(aₜ|x^{t}), at any time t, the right-hand side of (22) with the expectation operator removed represents an estimate of W(x^{t}, aₜ), and the goal of the critic is to minimize the difference between W(x^{t}, aₜ) and such estimate, in some embodiments. Therefore, the loss function of the critic network can be given by the following mean-squared error (MSE) loss:

$$( 23 )$$

$${ℒ}_{a}^{1} ( ϕ ) = 𝔼 [ {\sum }_{t = 1}^{T - 1} {( γ [ {\prod }_{θ} ( 0 \vert {x}^{t + 1} ) {w}_{ϕ} ( {x}^{t + 1} , 0 ) + \text{} {\prod }_{θ} ( 1 \vert {x}^{t + 1} ) {w}_{ϕ} ( {x}^{t + 1} , 1 ) ] + R ( {x}^{t} , {a}_{t} ) - {w}_{ϕ} ( {x}^{t} , {a}_{t} ) )}^{2} ] = \{ \begin{matrix}\begin{matrix}\begin{matrix}𝔼 [ \sum \begin{matrix}Γ - 1 \\ t = 1\end{matrix} ( γ [ ( 1 - {π}_{θ} ( {x}^{t + 1} ) ) {w}_{ϕ} ( {x}^{t + 1} , 0 ) + \\ {π}_{θ} ( {x}^{t + 1} ) {w}_{ϕ} ( {x}^{i + 1} , 1 ) ] + \\ {R ( {x}^{t} , 0 ) - {w}_{ϕ} ( {x}^{t} , 0 ) )}^{2} +\end{matrix} \\ \sum \begin{matrix}T - 1 \\ t = Γ\end{matrix} {( γ {w}_{ϕ} ( {x}^{i + 1} , 1 ) + R ( {x}^{t} , 1 ) - {w}_{ϕ} ( {x}^{t} , 1 ) )}^{2} ] ,\end{matrix} & if {Γ}_{2} \leq T - 1 , \\ \begin{matrix}𝔼 [ \sum \begin{matrix}T - 1 \\ t = 1\end{matrix} ( γ [ ( 1 - {π}_{θ} ( {x}^{t + 1} ) ) {w}_{ϕ} ( {x}^{t + 1} , 0 ) + \\ {π}_{θ} ( {x}^{t + 1} ) {w}_{ϕ} ( {x}^{t + 1} , 1 ) ] + \\ {R ( {x}^{i} , 0 ) - {w}_{θ} ( {x}^{t} , 0 ) )}^{2} ] ,\end{matrix} & no {Γ}_{2} ,\end{matrix}$$

On the other hand, the actor network π_{θ}(x^{t}) maps the input sequence x^{t} to the probability [symbol] (aₜ=1)=π_{θ}(x^{t}). Given the critic network w_{φ}(x^{t}, aₜ), using (18), and setting the baseline b(x^{t})=0, the loss function for the actor network can be written as:

$$( 24 )$$

$${ℒ}_{a}^{1} ( θ ) = \text{} - J ( θ ) = \{ \begin{matrix}\begin{matrix}- 𝔼 [ \sum \begin{matrix}{Γ}_{1} - 1 \\ t = 1\end{matrix} {γ}^{t} log ( 1 - {π}_{θ} ( {x}^{t} ) ) {w}_{ϕ} ( {x}^{t} , 0 ) + \\ log {π}_{θ} ( {x}^{Γ} ) {w}_{ϕ} ( {x}^{Γ} , 1 ) ] ,\end{matrix} & if Γ \leq T , \\ - 𝔼 [ \sum \begin{matrix}T \\ t = 1\end{matrix} {γ}^{t} log ( 1 - {π}_{θ} ( {x}^{t} ) ) {w}_{ϕ} ( {x}^{t} , 0 ) ] , & no Γ .\end{matrix}$$

Given the loss functions of the critic and the actor in (23)-(24), and a training set [symbol] , their respective gradients can be computed via automatic differentiation, in some embodiments.

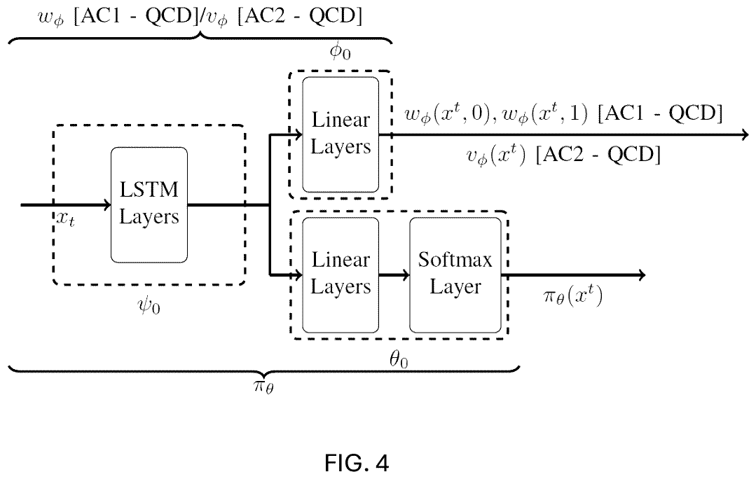

In accordance with some embodiments, an example network structure of AC1-QCD is shown in FIG. 4. In this network structure, in some embodiments, the shared single LSTM layer has an input dimension that can be equal to the data dimension and an output dimension can be equal to 16 (or any other suitable value). In this network structure, in some embodiments, the upper actor path do can include 2 (or any other suitable number) linear layers with 10 (or any other suitable number) neurons and 2 (or any other suitable number) neurons, respectively. In this network structure, in some embodiments, the lower critic path θ₀ can include 2 (or any other suitable number) linear layers with 10 (or any other suitable number) neurons and 1 (or any other suitable number) neuron, respectively, and a softmax layer.

In some embodiments, in the network structure of AC1-QCD shown in FIG. 4, the shared 2 (or any other suitable number) LSTM layers with hidden/output states' dimension of 64 (or any other suitable value) have a dropout rate of 0.25 (or any other suitable value), the upper actor path do includes 2 (or any other suitable number) linear layers with 64 (or any other suitable number) neurons and 2 (or any other suitable number) neurons, respectively, and the lower critic path θ₀ includes 2 (or any other suitable number) linear layers with 64 (or any other suitable number) neurons and 1 (or any other suitable number) neuron, respectively, and a softmax layer.

In some embodiments, the reward can be

$${c}_{t} = \{ \begin{matrix}{c}_{0} , & if t < τ , \\ {c}_{0} + a \times {b}^{t - τ} , & if t \geq τ ,\end{matrix}$$

where, c₀=1, a=1, b=0.5, or any other suitable values.

### Second Actor-Critic Algorithm

A second actor-critic algorithm in accordance with some embodiments can be referred to herein as Actor-Critic Algorithm 2 (AC1-QCD), and is now described.

In some embodiments, the second actor-critic algorithm uses a baseline to help reduce variance and increase stability.

Note that V(x^{t}) defined in (19) can be written recursively as follows:

$$( 28 )$$

$$V ( {x}^{t} ) = {𝔼}_{{\prod }_{θ}} [ R ( {x}^{t} , {a}^{t} ) + {\sum }_{{t}^{′} = t + 1}^{T} {γ}^{{t}^{′} - t} R ( {X}^{{t}^{′}} , {A}_{{t}^{′}} ) \vert {X}^{t + 1} = {x}^{t} ] = {\int }_{{x}^{t + 1}} p ( {x}^{t + 1} \vert {x}^{t} ) ( {r}_{t} + {γ𝔼}_{{\prod }_{θ}} [ {\sum }_{{t}^{′} = t + 1}^{T} {γ}^{{t}^{′} - t} R ( {X}^{{t}^{′}} , {A}_{{t}^{′}} ) \vert {X}^{t + 1} = {x}^{t + 1} ] ) = {\int }_{{x}^{t + 1}} p ( {x}^{t + 1} \vert {x}^{t} ) ( {r}_{t} + γ V ( {x}^{t + 1} ) ) = {r}_{t} + {γ𝔼}_{{\prod }_{θ}} [ V ( {x}^{t + 1} ) \vert {x}^{t} ] ,$$

where rₜ=R(x^{t}, 0)Π_{θ}(0|x^{t})+R(x^{t}, 1)Π_{θ}(1|x^{t}). A critic network v_{φ}(x^{t}) with parameter φ can be used to estimate V(x^{t}), in some embodiments. The right-hand side of (28) with the expectation operator removed represents an estimate of V(x^{t}). With the objective of minimizing the difference between such estimate and V(x^{t}), the loss function of the critic network can be given by the MSE loss:

$$( 25 )$$

$${ℒ}_{a}^{2} ( ϕ ) = 𝔼 [ {\sum }_{t = 1}^{T - 1} {( γ {v}_{ϕ} ( {x}^{t + 1} ) + {r}_{i} - {v}_{ϕ} ( {x}^{t} ) )}^{2} ] = \{ \begin{matrix}\begin{matrix}\begin{matrix}𝔼 [ \sum \begin{matrix}Γ - 1 \\ t = 1\end{matrix} ( γ {v}_{ϕ} ( {x}^{t + 1} ) + R ( {x}^{t} , 0 ) ( 1 - {π}_{0} ( {x}^{t} ) ) + \\ {R ( {x}^{t} , 1 ) {π}_{θ} ( {x}^{t} ) - {v}_{ϕ} ( {x}^{t} ) )}^{2} +\end{matrix} \\ {\sum }_{t = 1}^{T - 1} {( γ {v}_{ϕ} ( {x}^{t + 1} ) + R ( {x}^{t} , 1 ) - {v}_{ϕ} ( {x}^{t} ) )}^{2} ] ,\end{matrix} & if Γ \leq T - 1 \\ \begin{matrix}𝔼 [ \sum \begin{matrix}T - 1 \\ t = 1\end{matrix} ( γ {v}_{ϕ} ( {x}^{t + 1} ) + R ( {x}^{t} , 0 ) ( 1 - {π}_{0} ( {x}^{t} ) ) + \\ {R ( {x}^{t} , 1 ) {π}_{θ} ( {x}^{t} ) - {v}_{ϕ} ( {x}^{t} ) )}^{2} ] ,\end{matrix} & no Γ .\end{matrix}$$

For the actor network, the baseline b(x^{t})=V(x^{t}) in (18). To write the loss function of the actor network in terms of v_{φ}(x^{t}), the relationship between V and W in (19)-(20) can first be found as follows,

$$W ( {x}^{t} , {a}_{t} ) = {𝔼}_{{\prod }_{θ}} [ R ( {x}^{t} , {a}_{t} ) + {\sum }_{{t}^{′} = t + 1}^{T} {γ}^{{t}^{′} - t} R ( {X}^{{t}^{′}} , {A}_{{t}^{′}} ) \vert {X}^{t} = {x}^{t} , {A}_{t} , {a}_{t} ] = {\int }_{{x}^{t + 1}} p ( {x}^{t + 1} \vert {x}^{t} ) ( R ( {x}^{t} , {a}_{t} ) + {\sum }_{{a}_{t + 1}} {\prod }_{θ} ( {a}_{t + 1} \vert {x}^{t + 1} ) {γ𝔼}_{{\prod }_{θ}} [ {γ}^{{t}^{′} - t} R ( {X}^{{t}^{′}} , {A}_{{t}^{′}} ) \vert {X}^{t + 1} = {x}^{t + 1} , {A}_{t + 1} , {a}_{t + 1} ] ) = R ( {x}^{t} , {a}_{t} ) + γ {\int }_{{x}^{t + 1}} p ( {x}^{t + 1} \vert {x}^{t} ) {𝔼}_{{\prod }_{θ}} [ {\sum }_{{t}^{′} = t + 1}^{T} {γ}^{{t}^{′} - t} R ( {X}^{{t}^{′}} , {A}_{{t}^{′}} ) \vert {X}^{t + 1} = {x}^{t + 1} ] = R ( {x}^{t} , {a}_{t} ) + {γ𝔼}_{{\prod }_{θ}} [ V ( {x}^{t + 1} ) \vert {x}^{t} ] . \qquad ( 26 )$$

Therefore, the loss function for the actor network can be obtained by replacing w^{φ}(x^{t}, aₜ) with

$$R ( {x}^{t} , {a}_{t} ) + γ {v}_{ϕ} ( {x}^{t + 1} ) : \qquad ( 27 )$$

$${ℒ}_{a}^{2} ( θ ) = - J ( θ ) = \{ \begin{matrix}\begin{matrix}\begin{matrix}\begin{matrix}- 𝔼 [ \sum \begin{matrix}Γ - 1 \\ t = 1\end{matrix} {γ}^{t} log ( 1 - {π}_{θ} ( {x}^{t} ) ) ( γ {v}_{ϕ} ( {x}^{t + 1} ) + \\ R ( {x}^{t} , 0 ) - {v}_{ϕ} ( {x}^{t} ) ) +\end{matrix} \\ log {π}_{θ} ( {x}^{Γ} ) ( {γv}_{ϕ} ( {x}^{Γ + 1} ) +\end{matrix} \\ R ( {x}^{Γ} , 1 ) - {v}_{ϕ} ( {x}^{Γ} ) ) ] ,\end{matrix} & if Γ \leq T , \\ \begin{matrix}𝔼 [ \sum \begin{matrix}T \\ t = 1\end{matrix} {γ}^{t} log ( 1 - {π}_{θ} ( {x}^{t} ) ) ( γ {v}_{ϕ} ( {x}^{t + 1} ) + \\ R ( {x}^{t} , 0 ) - {v}_{ϕ} ( {x}^{t} ) ) ] ,\end{matrix} & no Γ\end{matrix}$$

The respective gradients for the critic and the actor network can be computed via automatic differentiation given (25) and (27), in some embodiments.

In accordance with some embodiments, an example network structure of AC2-QCD is shown in FIG. 4. In this network structure, in some embodiments, the shared single LSTM layer has an input dimension that can be equal to the data dimension and an output dimension can be equal to 16 (or any other suitable value). In this network structure, in some embodiments, both linear layer groups in the actor and the critic can include 2 (or any other number) linear layers with 10 (or any other number) neurons and 1 (or any other number) neuron, respectively. The critic path has an extra softmax layer following the linear layers, in some embodiments. In some embodiments, the LSTM layers can be implemented without the dropout regularization due to the simplicity of the data and the small number of LSTM cells.

In some embodiments, in the network structure of AC2-QCD shown in FIG. 4, the shared 2 (or any other number) LSTM layers can have hidden/output states of 64 (or any other number) dimensions and a dropout rate of 0.25 (or any other value), both linear layer groups in the actor and the critic can be composed of 2 (or any other number) linear layers with 64 (or any other number) neurons and 1 (or any other number) neuron, respectively, and the critic path can have an extra softmax layer following the linear layers.

In some embodiments, the reward can be

$${c}_{t} = \{ \begin{matrix}{c}_{0} , & if t < τ , \\ {c}_{0} + a \times {b}^{t - τ} , & if t \geq τ ,\end{matrix}$$

where, c₀=1, a=1, b=0.5, or any other suitable values.

### Training Actor-Critic OCD Algorithms

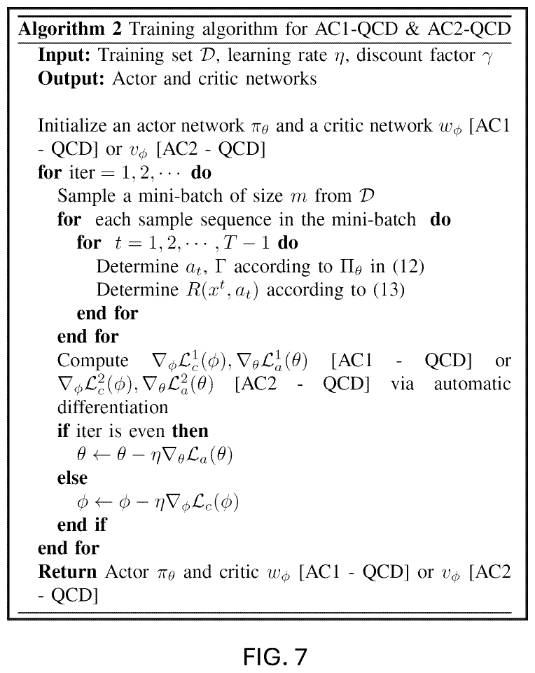

Examples of training processes for the two actor-critic QCD algorithms are given in Algorithm 2, shown in FIG. 7, in accordance with some embodiments. In both actor-critic QCD algorithms, the actor and critic are updated alternatively, in some embodiments. These steps are repeated until a pre-defined episode is reached, in some embodiments.

In the inference stage, only the actor π_{θ} is used to make decisions according to (12) given the available observations x^{t}.

As shown in FIG. 7, Algorithm 2 receives a training data set, a learning rate value, and a discount factor and outputs actor and critic networks. Any suitable training data set, learning rate value (e.g., 0.001), and discount factor (e.g., 0.9) can be used in some embodiments.

In some embodiments, Algorithm 2 can operate as follows:

During training, the algorithm can first initialize the actor network and the critic network. The actor network and the critic network can be initialized in any suitable manner, in some embodiments.

Then, for each of a given number of iterations, the algorithm can sample a mini-batch of data from the training data set. Any suitable number of iterations, any suitable mini-batch of data, and any suitable sizes of mini-batches can be used in some embodiments.

Then, for each time step of each sample sequence in each mini-batch, the algorithm can determine an action to be taken and a detection time (if any) based on the network as described in (12), and also determine a reward as described in (13).

Then, for each iteration, the algorithm can compute the respective gradients for the critic and the actor networks via automatic differentiation and then alternatively update the actor and critic networks based on the iteration.

After the iterations are complete, the Algorithm can output actor and critic networks that are used to determine if an anomaly has occurred.

As noted above, an example network structure for the actor-critic algorithms is shown in FIG. 4, in accordance with some embodiments. In some embodiments, recurrent layers can be used as the internal state update function, which is denoted by ψ₀. Considering the underlying connection between the actor and critic networks, it is effective to share ψ₀, in some embodiments. As shown in the figure, following wo, there are two distinct paths. The lower path, denoted by θ₀, includes of some linear layers followed by a softmax layer and is responsible for outputting the decision probability [symbol] (aₜ=1). The upper path, denoted by φ₀, includes some different linear layers and is responsible for mapping the internal state to an estimate of the cumulative reward. The actor is responsible for decision-making and is denoted by π_{θ}, where θ=(ψ₀, θ₀). The critic provides feedback on the quality of the actor's decisions during training, helping the actor to improve its policy, and is denoted by w_{φ} and v_{φ} respectively in AC1-QCD and AC2-QCD, respectively, where φ=(ψ₀, φ₀).

### Transient Change Detection

In some applications such as radar, sonar, intrusion detection, and industrial monitoring, the change is transient, i.e., the changes in observations disappear after occurring for a short period of time. In such applications, in some embodiments, the data model can become

$${x}_{c} ∼ = \{ \begin{matrix}{f}_{0} , & if t < {τ}_{1} , \\ {f}_{1} \neq {f}_{0} , & if {τ}_{1} \leq t < {τ}_{2} , \\ {f}_{0} , & if t \geq {τ}_{2} ,\end{matrix} \qquad ( 29 )$$

where the change lasts for the time period τ₁≤t<τ₂. In transient change detection, the decision network needs to detect the changes before it disappears. Let Γ₁ and Γ₂ denote the first time an alarm is raised and released respectively. If Γ₁<τ₁, then a false alarm has occurred. If τ₁≤Γ₁<τ₂, the change is detected successfully. If Γ₁≥τ₂ or Γ₁ never appears, a missed detection occurred. In accordance with some embodiments, the goal is to maximize the probability of detection (PD), or equivalently to minimize the probability of missed detection (PMD), while maintaining a reasonable probability of false alarm (PFA). When the change occurs, the alarm should be raised as soon as possible, and when the change disappears, the alarm should be released as quickly as possible, in some embodiments.

Therefore, in accordance with some embodiments, different reward functions including two parts can be implemented for this task. Specifically, if an alarm is not raised when a change occurs, i.e., τ₁≤t<τ₂, a large constant penalty is incurred at t=τ₂−1, in some embodiments. Hence, a first part of the reward can be given by

$${R}_{1} ( {x}^{t} , {a}_{t} ) = \{ \begin{matrix}- {c}_{p} & if t = {τ}_{2} - 1 , {a}_{i} = 0 for i = \{ {τ}_{1} , ⋯ , {τ}_{2} - 1 \} , \\ 0 & otherwise ,\end{matrix} \qquad ( 30 )$$

where cₚ>0. Note that R₁(x^{t}, aₜ) is zero for all time instants except at t=τ₂−1, in some embodiments. A second part of the reward function can be similar to the regular reward in (13), that assigns a smaller reward each time, encouraging the network to take the correct actions, in some embodiments. In some embodiments, it can be given by

$${R}_{2} ( {x}^{t} , {a}_{t} ) = \{ \begin{matrix}{c}_{0} & if t < {τ}_{1} , {a}_{t} = 0 , \\ - {c}_{0} & if t < {τ}_{1} , {a}_{t} = 1 , \\ {c}_{t} & if {τ}_{1} \leq t < {τ}_{2} , {a}_{t} = 1 , \\ - {c}_{t} & if {τ}_{1} \leq t < {τ}_{2} , {a}_{t} = 0 , \\ {c}_{t}^{′} & if t \geq {τ}_{2} , {a}_{t} = 0 , \\ - {c}_{t}^{′} & if t \geq {τ}_{2} , {a}_{t} = 1 ,\end{matrix} \qquad ( 31 )$$

where c₀>0 is a constant, cₚ>>c_{τ}_{₁}≥c_{τ}_{₁}₊₁≥ . . . ≥c₀>0 and cₚ>>c′_{τ}_{₂}≥c′_{τ}_{₂}₊₁≥ . . . ≥c₀>0. Thus, the overall reward for the transient change detection task can be

$$R ( {x}^{t} , {a}_{t} ) = {R}_{1} ( {x}^{t} , {a}_{t} ) + {R}_{2} ( {x}^{t} , {a}_{t} ) , \qquad ( 32 )$$

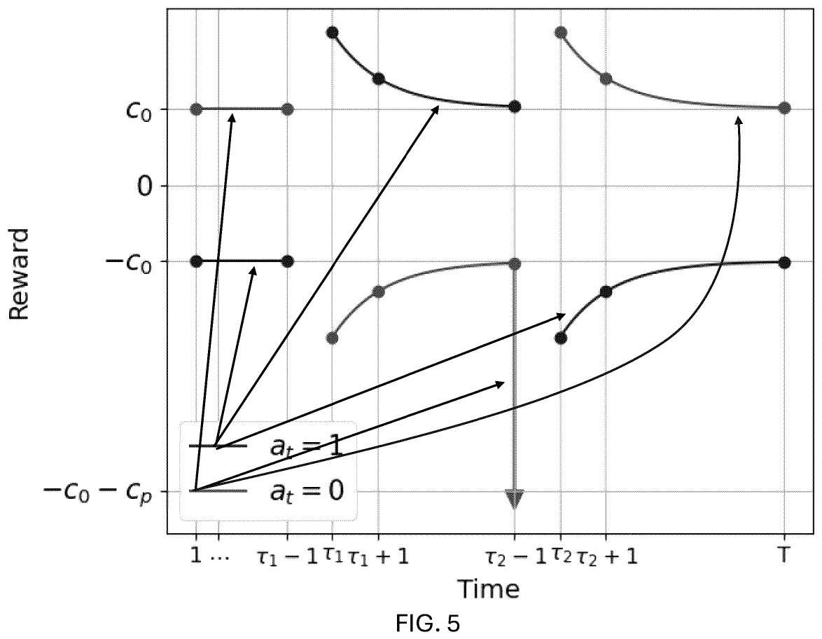

which is illustrated in FIG. 5.

An objective is to maximize the cumulative reward in (15), in some embodiments.

In some embodiments, during the training stage, at each time t, a probabilistic decision can be made based on the network output [symbol] (aₜ=1)=π_{θ}(x^{t}). Let IT be the first time that a_{Γ}_{₁}=1, let Γ₂>Γ₁ be the first time after Γ₁ that a_{Γ}_{₂}=0, and let the subsequent decisions for t>Γ₂ be aₜ=0. Thus, the overall policy for transient change detection is then

$${\prod }_{θ} ( {a}_{t} = 1 \vert {x}^{t} ) = \{ \begin{matrix}{π}_{θ} ( {x}^{t} ) , & if t \leq {Γ}_{2} , \\ 0 , & otherwise .\end{matrix} \qquad ( 33 )$$

By properly modifying the corresponding loss functions, both Algorithm 1 and Algorithm 2 for transient change detection, in some embodiments. For example, in some embodiments, when AC2-QCD is applied for transient change detection, the loss functions of the critic and actor are given respectively by (34) and (35) (shown below), where R(x^{t}, aₜ) is given by (32).

$$( 34 )$$

$${\tilde{ℒ}}_{a}^{2} ( ϕ ) = 𝔼 [ {\sum }_{t = 1}^{T - 1} {( γ {v}_{ϕ} ( {x}^{i + 1} ) + {r}_{x} - {v}_{ϕ} ( {x}^{t} ) )}^{2} ] = \{ \begin{matrix}\begin{matrix}\begin{matrix}𝔼 [ \sum \begin{matrix}{Γ}_{2} - 1 \\ t = 1\end{matrix} ( γ {v}_{ϕ} ( {x}^{i + 1} ) + R ( {x}^{i} , 0 ) ( 1 - {π}_{θ} ( {x}^{i} ) ) + \\ {R ( {x}^{i} , 1 ) {π}_{θ} ( {x}^{t} ) - {v}_{ϕ} ( {x}^{t} ) )}^{2} +\end{matrix} \\ [ \sum \begin{matrix}T - 1 \\ t = {Γ}_{2}\end{matrix} {( γ {v}_{ϕ} ( {x}^{i + 1} ) + R ( {x}^{i} , 0 ) - {v}_{ϕ} ( {x}^{i} ) )}^{2} ] ,\end{matrix} & if {Γ}_{2} \leq T - 1 , \\ \begin{matrix}𝔼 [ \sum \begin{matrix}T - 1 \\ t = 1\end{matrix} ( γ {v}_{ϕ} ( {x}^{i + 1} ) + R ( {x}^{i} , 0 ) ( 1 - {π}_{θ} ( {x}^{i} ) ) + \\ {R ( {x}^{i} , 1 ) {π}_{θ} ( {x}^{t} ) - {v}_{ϕ} ( {x}^{t} ) )}^{2} ] ,\end{matrix} & no {Γ}_{2} ,\end{matrix}$$

$${\tilde{ℒ}}_{a}^{2} ( θ ) = \{ \begin{matrix}\begin{matrix}\begin{matrix}- 𝔼 [ \sum \begin{matrix}{Γ}_{1} - 1 \\ t = 1\end{matrix} {γ}^{t} log ( 1 - {π}_{θ} ( {x}^{t} ) ) ( γ v ( {x}^{t + 1} ) + \\ R ( {x}^{i} , 0 ) - v ( {x}^{t} ) ) + \\ \sum \begin{matrix}{Γ}_{2} - 1 \\ t = {Γ}_{1}\end{matrix} {γ}^{t} log ( 1 - {π}_{θ} ( {x}^{t} ) ) ( γ v ( {x}^{t + 1} ) + \\ R ( {x}^{i} , 1 ) - v ( {x}^{t} ) ) +\end{matrix} \\ log {π}_{θ} ( {x}^{{Γ}_{2}} ) ( γ v ( {x}^{{Γ}_{2} + 1} ) + R ( {x}^{Γ} , 0 ) - v ( {x}^{{Γ}_{2}} ) ) ] ,\end{matrix} & if {Γ}_{1} < {Γ}_{2} \leq T , \\ \begin{matrix}- 𝔼 [ \sum \begin{matrix}{Γ}_{1} - 1 \\ t = 1\end{matrix} {γ}^{t} log ( 1 - {π}_{θ} ( {x}^{t} ) ) ( γ v ( {x}^{t + 1} ) + \\ R ( {x}^{t} , 0 ) - v ( {x}^{t} ) ) + \\ \sum \begin{matrix}T \\ t = {Γ}_{1}\end{matrix} {γ}^{t} log ( 1 - {π}_{θ} ( {x}^{i} ) ) ( γ v ( {x}^{t + 1} ) + \\ R ( {x}^{t} , 1 ) - v ( {x}^{t} ) ) ] ,\end{matrix} & if {Γ}_{1} \leq T , no {Γ}_{2} \\ \begin{matrix}- 𝔼 [ \sum \begin{matrix}T \\ t = 1\end{matrix} {γ}^{t} log ( 1 - {π}_{θ} ( {x}^{t} ) ) ( γ v ( {x}^{t + 1} ) + \\ R ( {x}^{t} , 0 ) - v ( {x}^{t} ) ) ] ,\end{matrix} & no {Γ}_{1} ,\end{matrix} \qquad ( 35 )$$

In some embodiments, the mechanisms for anomaly detection described herein can be applied to any suitable application. For example, in some embodiments, these mechanisms can be used to monitor network traffic data for an IoT network under normal system operation as well as under IoT botnet attacks. If an attack is detected, the mechanisms can trigger an action to secure the network (e.g., shut down the network, block external traffic, alert a user, etc.).

As another example, in some embodiments, the mechanism can be used to monitor solar data to detect solar flare events as quickly and precisely as possible. When solar flares are detected, these mechanisms can initiate remedial action to protect equipment from the solar flares, thereby making the equipment more robust to solar flares.

As yet another example, in some embodiments, these mechanisms can be used to monitor credit card transactions for fraudulent transactions. In this way, these mechanisms can be used to make credit card transaction systems more secure.

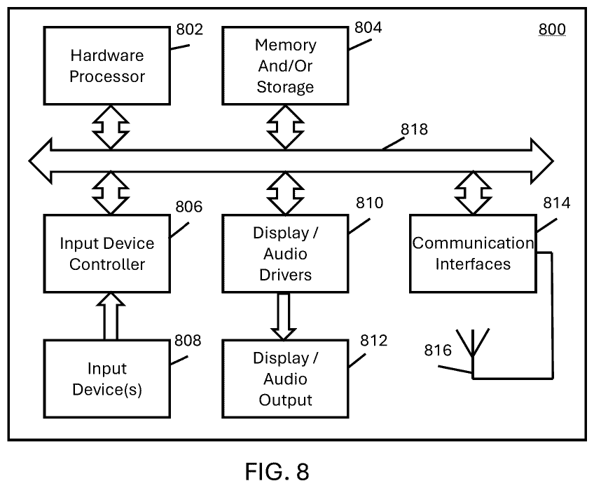

The networks and algorithms described herein can be implemented in any suitable computing devices. For example, in some embodiments, the networks and algorithms described herein can be implemented using any suitable general-purpose computer or special-purpose computer(s). Any such general-purpose computer or special-purpose computer can include any suitable hardware. For example, as illustrated in example hardware 800 of FIG. 8, such hardware can include hardware processor 802, memory and/or storage 804, an input device controller 806, an input device 808, display/audio drivers 810, display and audio output circuitry 812, communication interface(s) 814, an antenna 816, and a bus 818.

Hardware processor 802 can include any suitable hardware processor, such as a graphical processing unit (GPU), a tensor processing unit (TPU), a microprocessor, a micro-controller, digital signal processor(s), dedicated logic, and/or any other suitable circuitry for controlling the functioning of a general-purpose computer or a special purpose computer in some embodiments.

Memory and/or storage 804 can be any suitable memory and/or storage for storing programs, data, and/or any other suitable information in some embodiments. For example, memory and/or storage 804 can include random access memory, read-only memory, flash memory, hard disk storage, optical media, and/or any other suitable memory.

Input device controller 806 can be any suitable circuitry for controlling and receiving input from input device(s) 808, in some embodiments. For example, input device controller 806 can be circuitry for receiving input from an input device 808, such as a touch screen, from one or more buttons, from a voice recognition circuit, from a microphone, from a camera, from an optical sensor, from an accelerometer, from a temperature sensor, from a near field sensor, an automobile navigation system, from a global positioning system, and/or any other type of input device.

Display/audio drivers 810 can be any suitable circuitry for controlling and driving output to one or more display/audio output circuitries 812 in some embodiments. For example, display/audio drivers 810 can be circuitry for driving one or more display/audio output circuitries 812, such as an LCD display, a speaker, an LED, or any other type of output device.

Communication interface(s) 814 can be any suitable circuitry for interfacing with one or more communication networks. For example, interface(s) 814 can include network interface card circuitry, wireless communication circuitry, and/or any other suitable type of communication network circuitry.

Antenna 816 can be any suitable one or more antennas for wirelessly communicating with a communication network in some embodiments. In some embodiments, antenna 816 can be omitted when not needed.

Bus 818 can be any suitable mechanism for communicating between two or more components 802, 804, 806, 810, and 814 in some embodiments.

Any other suitable components can additionally or alternatively be included in hardware 800 in accordance with some embodiments.

It should be understood that at least some of the above-described operations of the algorithms of FIGS. 6 and 7 can be executed or performed in any order or sequence not limited to the order and sequence shown in and described in the figures. Also, some of the above operations of the algorithms of FIGS. 6 and 7 can be executed or performed substantially simultaneously where appropriate or in parallel to reduce latency and processing times. Additionally or alternatively, some of the above-described operations of the algorithms of FIGS. 6 and 7 can be omitted

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable non-transitory tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for anomaly detection, comprising:
initializing a policy network;
sampling a mini-batch of data from a training data set, wherein each mini-batch has a plurality of sample sequences, each having a plurality of time steps;
for each time step of each sample sequence in each mini-batch:
determining an action to be taken based on the policy of the network; and
determining a reward;
determining a gradient of an expected discounted cumulative reward; and
updating the policy.
